(19) United States
(12) Patent Application Publication
(10) Pub. No.: US 2026/0088682 A1
(43) Pub. Date: Mar. 26, 2026

(54) CHOKE SYSTEM FOR REDUCING COMMON MODE CURRENTS IN ALTERNATING CURRENT DRIVE SYSTEMS

(71) Applicant: GM GLOBAL TECHNOLOGY OPERATIONS LLC., Detroit, MI (US)

(72) Inventors: Alireza Fatemi, Canton, MI (US); Brian J. Gallert, Lake Orion, MI (US)

(73) Assignee: GM GLOBAL TECHNOLOGY OPERATIONS LLC, Detroit, MI (US)

(21) Appl. No.: 18/891,280

(22) Filed: Sep. 20, 2024

(51) Int. Cl. H02K 11/02; H02K 11/01; H02K 11/30

(52) U.S. Cl. CPC H02K 11/02; H02K 11/01; H02K 11/30

(57) ABSTRACT

The present disclosure addresses common mode and bearing currents in alternating current (AC) drive systems by using an AC choke assembly integrated with shielded coaxial electrical cables. This design mitigates common mode currents and ensures electromagnetic compatibility. The AC choke assembly comprises a magnetic core with an axial bore that holds the coaxial electrical cables. The cables are surrounded by a metallic casing and are insulated by a dielectric separator. An optional dielectric external cover may further insulate the metallic casing. Thermal interface paste may be used to maximize thermal conduction between the various layers of the AC choke. One side of the metallic casing connects to a first set of coaxial cable shield ends, or the other side may be connected to a traction drive unit (TDU) or a traction power invertor module (TPIM). Alternatively, the AC choke may be located in a middle section of the coaxial cables.

### INTRODUCTION

This disclosure relates to alternating current (AC) chokes for use with all-electric or hybrid-electric automotive vehicles, and other electrical applications that require reduction of common mode and bearing currents in AC drive systems using shielded cables.

All-electric and/or hybrid electric vehicles may use AC traction drive units (TDU) for propelling the vehicle. A direct current/alternating current (DC/AC) traction power invertor module (TPIM) may be used to provide alternating current to the TDU's. High frequency (up to about 10 MHz), electromagnetic noise may be emitted from the AC power system of an electric vehicle (e.g., from the invertor module), which may interfere with radio, sensor, guidance, and computer operations inside of the vehicle. AC chokes, made of an iron-based material, may be used to reduce or mitigate high-frequency common mode and bearing currents in current-carrying conductors or buses. Overheating of the magnetic core of an AC choke may lower the core's magnetic permeability and reduce the choke's shielding performance.

### SUMMARY

The present disclosure addresses common mode and bearing currents in alternating current (AC) drive systems by using an AC choke assembly integrated with shielded coaxial electrical cables. This design mitigates common mode currents and ensures electromagnetic compatibility. The AC choke assembly comprises a magnetic core defining an axial bore that holds the coaxial electrical cables. The cables are surrounded by a metallic casing and are insulated by a dielectric separator. An optional dielectric external cover may further insulate the metallic casing. Thermal interface paste may be used to maximize thermal conduction between the various layers of the AC choke. One side of the metallic casing connects to a first set of coaxial cable shield ends, or the other side may be connected to a traction drive unit (TDU) or a traction power invertor module (TPIM). Alternatively, the AC choke may be located in a middle section of the coaxial cables.

The methods and devices disclosed herein address reduction of common mode and bearing currents in an electric traction drive system of a vehicle. The disclosure teaches an AC choke assembly that effectively reduces and mitigates common mode currents in AC drive systems. This helps in reducing electrical noise and interference, leading to improved system performance and reliability. By using a metallic casing for an AC choke assembly, this effectively mitigates electromagnetic interference (EMI). This helps in complying with EMC regulations and standards, ensuring that the system operates without interfering with other electronic devices in the vehicle. The use of thermal interface materials in the AC choke assembly helps to maximize thermal conductance across adjacent layers. This improves the heat dissipation capabilities of the AC choke, thereby preventing overheating and ensuring optimal performance and longevity of the system. The presented designs enable easy integration of the AC choke assembly into the coaxial electrical cable system of AC drive systems. Options are disclosed for connecting the metallic casing to coaxial cable shield terminations, or for connecting the magnetic core to coaxial shield terminations (i.e., shield ends), thereby offering flexibility in system design and installation. The AC choke may be located over an unshielded portion of the coaxial electrical cable, which reduces the mean magnetic length of the AC choke design and results in higher magnetic inductance of the system (and, hence, better electromagnetic shielding). Typical AC current frequencies may range from 1 to 10 MHz.

In a first embodiment, an AC choke for reducing common mode and bearing currents in AC drive systems includes a magnetic core that defines an axial bore located inside of the magnetic core, a dielectric separator surrounding the magnetic core, and a metallic casing surrounding the dielectric separator. The dielectric separator electrically isolates the magnetic core from the metallic casing. The AC choke may further have a first gap disposed in-between the magnetic core and the dielectric separator, a second gap disposed in-between the dielectric separator and the metallic casing; a first layer of a thermal interface material filling the first gap, and a second layer of the thermal interface material filling the second gap. An optional dielectric outer jacket may surround the metallic casing. An optional third layer of thermal interface material may be placed in-between the metallic casing and the optional dielectric outer jacket. The magnetic core may be a ferrite material or nanocrystalline ferrous material. The dielectric separator and the optional dielectric outer jacket may be a semi-crystalline, thermoplastic high temperature polymer material (e.g., polyphenylene sulfide (PPS)). The metallic casing may be an aluminum alloy and/or a steel alloy.

In some embodiments, the magnetic core may have a shape that is rectangular, rounded rectangular, circular, triangular, or rounded triangular.

In some embodiments, the magnetic core may be made of a plurality of nanocrystalline ferrous ribbons wound in a rounded rectangular geometry with an axial bore disposed inside of the magnetic core.

In some embodiments, the AC choke has at least one coaxial electrical cable placed inside of, and passing through, the bore located inside of the magnetic core. Each coaxial electrical cable includes an axial central conductor, a coaxial dielectric insulator surrounding the axial central conductor, a conductive coaxial shield surrounding the coaxial dielectric insulator, and a dielectric coaxial jacket surrounding the conductive coaxial shield.

In some embodiments, the AC choke is located along a middle section of a coaxial electrical cable.

In some embodiments, the AC choke is located at an end of a coaxial electrical cable.

In some embodiments, the conductive coaxial shield is electrically connected to an outer surface of the metallic casing of the AC choke. In other embodiments, the conductive coaxial shield is electrically connected to an inner surface of the metallic casing of the AC choke.

In some embodiments, a portion of the dielectric coaxial jacket and the conductive coaxial shield are peeled away from the at least one coaxial electrical cable, thereby defining an exposed portion of the conductive coaxial shield, and thereby defining an unshielded axial portion of the at least one coaxial electrical cable. The conductive coaxial shield may be discontinuous along an unshielded axial portion. The AC choke may be located over the unshielded axial portion of the coaxial electrical cable.

In some embodiments, the metallic casing of the AC choke is electrically connected to a metallic housing of a TDU, and the conductive coaxial shield is connected to the metallic casing.

In some embodiments, the metallic casing of the AC choke is electrically connected to a metallic housing of a TPIM, and the conductive coaxial shield is connected to the metallic casing.

In some embodiments, the conductive coaxial shield is connected to the magnetic core, and the metallic casing and the dielectric separator are not present.

In some embodiments, three parallel coaxial electrical cables are located inside of, and passing through, the bore located inside of the magnetic core of the AC choke.

In some embodiments, an AC choke assembly includes a TDU that connects to the metal casing of the AC choke.

In some embodiments, a system for reducing common mode and bearing currents in AC drive systems includes an AC drive system with an AC traction motor and associated power electronics connected through the one or more coaxial electrical cables; and an AC choke assembly that is integrated with the one or more coaxial electrical cables for reducing common mode currents and ensuring EMC.

In some embodiments, an AC drive system includes an AC choke with one or more coaxial electrical cables passing through the AC choke, which are connected to a TDU configured for use in an electric vehicle.

In some embodiments, an AC drive system includes an AC choke with one or more coaxial electrical cables passing through the AC choke, which are connected to a TPIM configured for use in an electric vehicle.

In some embodiments, exposed surfaces of the AC choke are covered in a dielectric insulating material.

In some embodiments, the metallic casing is eliminated, and the conductive coaxial shield is connected to the magnetic core of the AC choke.

In some embodiments, a vehicle includes a vehicle body, one or more road wheels connected to the vehicle body, and an AC choke assembly connected to the vehicle body. The AC choke assembly includes an AC choke, at least one coaxial electrical cable disposed inside of, and passing through, the AC choke, and a traction drive unit (TDU) or a traction power invertor module (TPIM) connected to the AC choke. The AC choke has a magnetic core, an axial bore defined by the magnetic core, a dielectric separator surrounding the magnetic core, and a metallic casing surrounding the dielectric separator. The dielectric separator electrically isolates the magnetic core from the metallic casing. The at least one coaxial electrical cable has an axial central conductor, a coaxial dielectric insulator surrounding the axial central conductor, a conductive coaxial shield surrounding the coaxial dielectric insulator, and a dielectric coaxial jacket surrounding the conductive coaxial shield. The axial central conductor is connected to the TDU or TPIM, and the conductive coaxial shield is connected to the metallic casing.

### BRIEF DESCRIPTION OF THE DRAWINGS

FIG. 1A shows a cut-away perspective view of an example of a coaxial electrical cable.

FIG. 1B shows a cut-away perspective view of an example of a coaxial electrical cable with a portion of central axial conductor exposed at one end.

FIG. 2A shows a schematic perspective cross-sectional view of an example of a rectangular AC choke, according to the present disclosure.

FIG. 2B shows a schematic perspective cross-sectional view of an example of a rectangular AC choke assembly with three parallel, coaxial electrical cables disposed inside, according to the present disclosure.

FIG. 3A shows a schematic perspective view of an example of a monolithic, rectangular magnetic core with rounded corners, according to the present disclosure.

FIG. 3B shows a schematic perspective view of an example of a monolithic, rectangular magnetic core assembly with rounded corners and three parallel, coaxial electrical cables disposed inside, according to the present disclosure.

FIG. 4A shows a schematic perspective cross-sectional view of an example of a rectangular AC choke with rounded corners, according to the present disclosure.

FIG. 4B shows a schematic perspective cross-sectional view of an example of a rectangular AC choke assembly with rounded corners and three parallel, coaxial electrical cables disposed inside, according to the present disclosure.

FIG. 5A shows a schematic perspective cross-sectional view of an example of a circular AC choke, according to the present disclosure.

FIG. 5B shows a schematic perspective cross-sectional view of an example of a circular AC choke assembly with three parallel, coaxial electrical cables disposed inside, according to the present disclosure.

FIG. 6A shows a schematic perspective cross-sectional view of an example of a triangular AC choke, according to the present disclosure.

FIG. 6B shows a schematic perspective cross-sectional view of an example of a triangular AC choke assembly with three parallel, coaxial electrical cables disposed inside, according to the present disclosure.

FIG. 7 shows a schematic top plan view of an example of an AC choke assembly comprising an AC choke with three parallel, coaxial electrical cables disposed inside of, and passing through, the AC choke in the Z-axis direction, according to the present disclosure.

FIG. 8A shows a schematic side cross-section view (Section A-A) of the example shown in FIG. 7 of a coaxial electrical cable electrically and mechanically integrated with an AC choke, according to the present disclosure.

FIG. 8B shows a schematic side cross-section view (Section A-A) of the example shown in FIG. 7 of a coaxial electrical cable electrically and mechanically integrated with an AC choke, according to the present disclosure.

FIG. 9A shows a schematic top plan view of an example of an AC choke attached to either a traction drive unit (TDU) or to a traction power invertor module (TPIM), with three parallel, coaxial electrical cables disposed inside of, and passing through, the AC choke in the Z-axis direction, according to the present disclosure.

FIG. 9B shows a schematic top plan view of an example of an AC choke attached to either a traction drive unit (TDU) or to a traction power invertor module (TPIM), with three parallel, coaxial electrical cables disposed inside of, and passing through, the AC choke in the Z-axis direction, according to the present disclosure.

FIG. 10 shows a schematic side cross-section view (Section B-B) of the example shown in FIG. 9A of a coaxial electrical cable electrically and mechanically integrated with an AC choke that is attached to a TPIM or TDU power unit, according to the present disclosure.

FIG. 11A shows a schematic top plan view of an example of an AC choke housed in a sheet metal housing, according to the present disclosure.

FIG. 11B shows a schematic bottom plan view of an example of an AC choke housed in a sheet metal housing, according to the present disclosure.

FIG. 11C shows a schematic front elevation view of an example of an AC choke housed in a sheet metal housing, according to the present disclosure.

FIG. 11D shows a schematic side elevation view of an example of an AC choke housed in a sheet metal housing, according to the present disclosure.

FIG. 12 shows a schematic front elevation cross-sectional view of an example of a magnetic core of an AC choke, according to the present disclosure.

FIG. 13 shows a schematic perspective view of an example of a triangular magnetic core of an AC choke, according to the present disclosure.

FIG. 14 shows a schematic perspective view of an example of a vehicle with an AC choke assembly, according to the present disclosure.

### DETAILED DESCRIPTION OF THE DISCLOSURE

The AC choke assemblies disclosed herein may be used in number of different mobile electric or hybrid-electric applications, including, but not limited to: automobiles, trucks, motorcycles, boats, submarines, airplanes, jets, spacecraft, trains or other mobile platforms, as well as non-mobile electric systems, such as power plants, appliances, and photovoltaic solar installations. The phrase “vehicle” is broadly defined as any moving machine, including, but not limited to: automobiles, trucks, motorcycles, boats, submarines, aircraft, spacecraft, trains, or other mobile platforms.

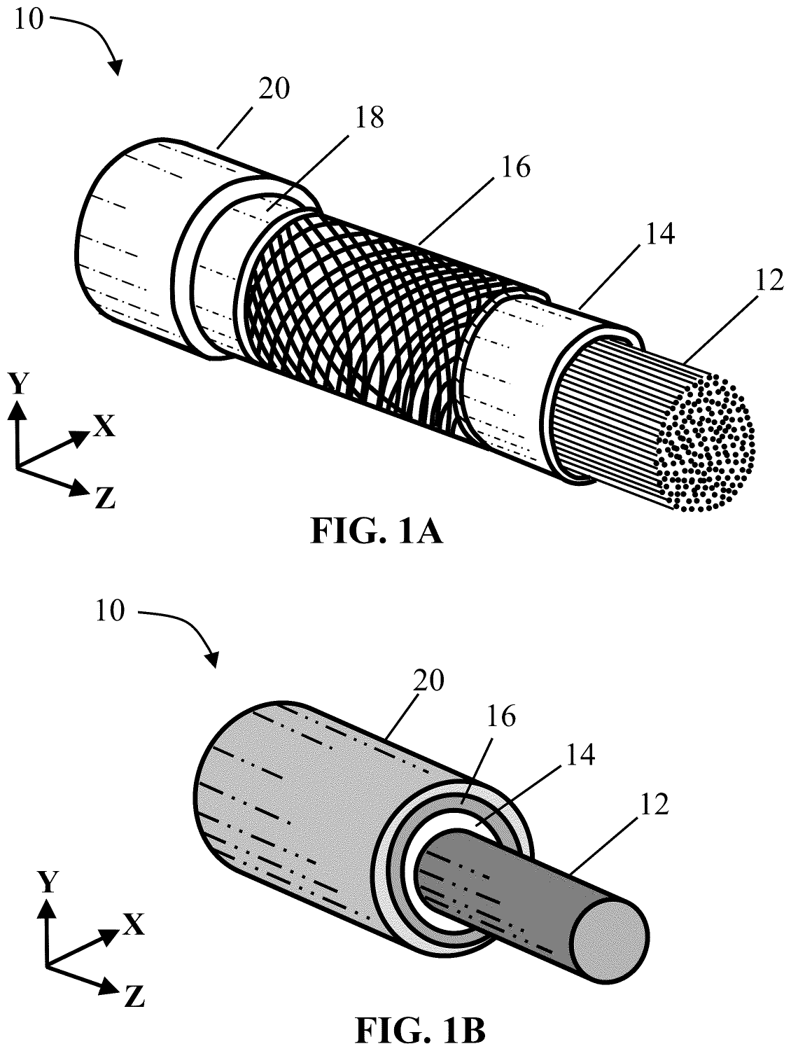

FIG. 1A shows a cut-away perspective view of an example of a coaxial electrical cable 10. Cable 10 comprises layers: an electrically conductive axial central conductor 12 (e.g., thick solid copper wire or stranded thin copper wires); which is covered by a coaxial dielectric insulator 14; which is covered by a first conducive coaxial shield 16 (which may comprise a braided array of conductive aluminum or copper wires); which is optionally covered by an second conductive shield layer 18 (e.g., aluminum foil), which is finally covered by an dielectric coaxial jacket 20 (which may comprise a dielectric insulating material).

FIG. 1B shows a simplified perspective view of an example of a coaxial electrical cable 10 with a portion of central axial conductor 12 exposed at one end. In this example, coaxial dielectric insulator 14, conductive coaxial shield 16, and dielectric coaxial jacket 20 have been partially stripped away and removed, leaving an exposed length of central axial conductor 12.

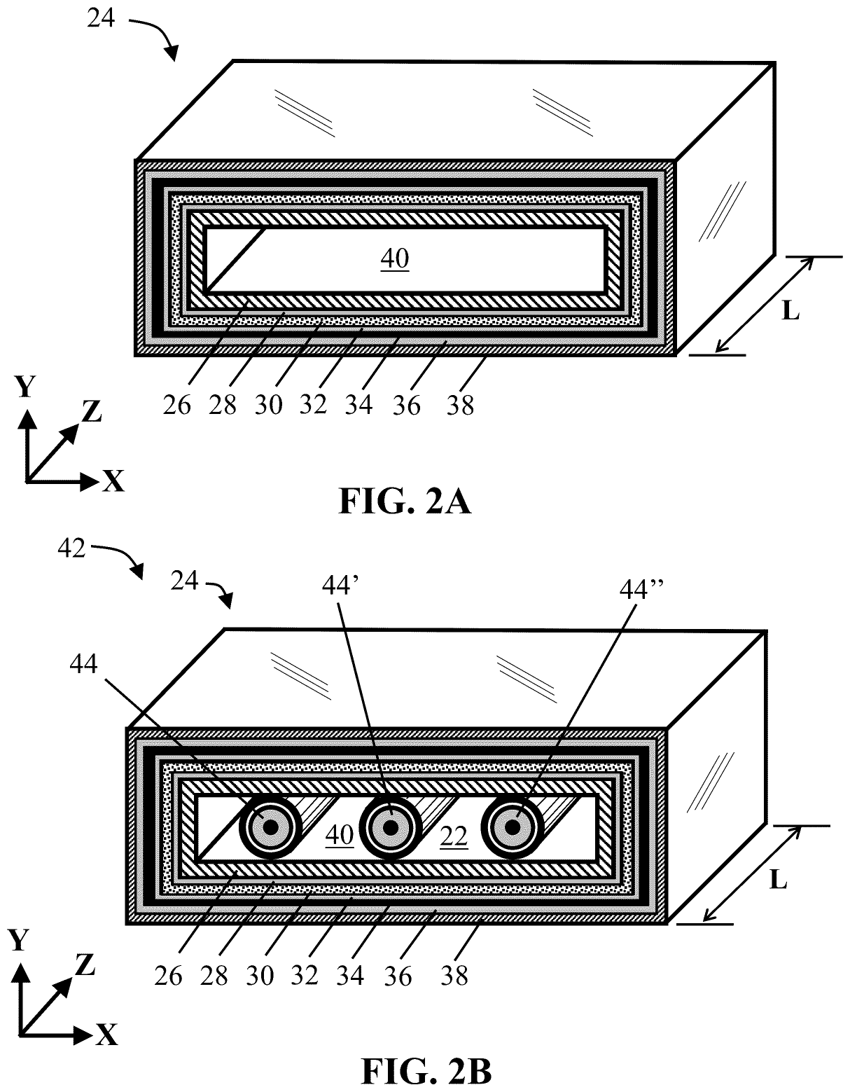

FIG. 2A shows a schematic perspective cross-sectional view of an example of a rectangular AC choke 24, according to the present disclosure. Choke 24 has a rectangular shape, having an axial length=L (along the Z-axis direction). Choke 24 comprises a hollow magnetic core 26 made of an iron-based magnetoc material (e.g., iron-based ferrous or ferrite material, or nanocrystalline iron-based amorphous ribbon material), that defines a rectangular bore 40 located inside of magnetic core 26. Moving outwards, the next layer comprises a first layer of a thermally conductive material 28 (e.g., thermal paste). Moving outwards, the next layer comprises a dielectric separator 30, made of a dielectric material (e.g., a Polyamide, Polyphenylene Sulfide, an Epoxy Resin, and/or a Polycarbonate, etc.). Moving outwards, the next layer comprises a second layer of a thermally conductive material 32 (e.g., thermal paste). Moving outwards, the next layer comprises a metallic casing 34 (e.g., aluminum alloy or steel alloy, or a combination thereof). Moving outwards, the next layer comprises a third layer of a thermally conductive material 36 (e.g., thermal paste). Finally, the outermost layer of choke 24 comprises a dielectric outer jacket 38 made of an insulating material (e.g., a Polyamide, Polyphenylene Sulfide, an Epoxy Resin, and/or a Polycarbonate, etc.).

Referring still to FIG. 2A, in some embodiments the third layer of thermally conductive material 36 (e.g., thermal paste) and the dielectric outer jacket 38 may optionally be omitted. This configuration makes the metallic casing 34 the outermost layer, in this embodiment.

FIG. 2B shows a schematic perspective cross-sectional view of an example of a rectangular AC choke assembly 42, having an axial length=L (along the Z-axis direction), with three parallel, coaxial electrical cables 44, 44′, and 44″ disposed inside of, and passing through, bore 40 of choke 24, according to the present disclosure. The remaining, unused open space 22 located in-between coaxial electrical cables 44, 44′, and 44″ may be filled with a dielectric material, in some embodiments.

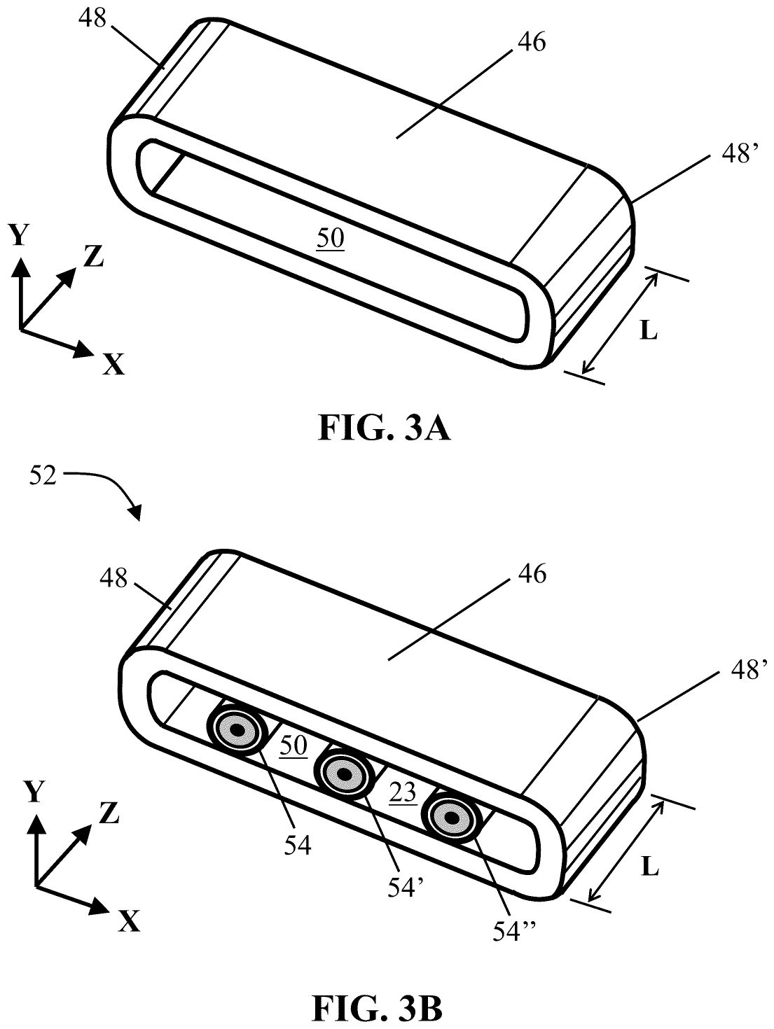

FIG. 3A shows a schematic perspective view of an example of a monolithic, rectangular magnetic core 46, having an axial length=L (along the Z-axis direction), and four rounded corners 48, 48′, etc., according to the present disclosure. The interior of magnetic core 46 defines an axial bore 50.

FIG. 3B shows a schematic perspective view of an example of a monolithic, rectangular magnetic core assembly 52, having an axial length=L (along the Z-axis direction), with four rounded corners 48, 48′, etc., and three parallel, coaxial electrical cables 54, 54′, 54″ disposed inside of, and passing through, axial bore 50 of magnetic core 46, according to the present disclosure. The remaining, unused open space 23 located in-between coaxial electrical cables 54, 54′, and 54″ may be filled with a dielectric material, in some embodiments.

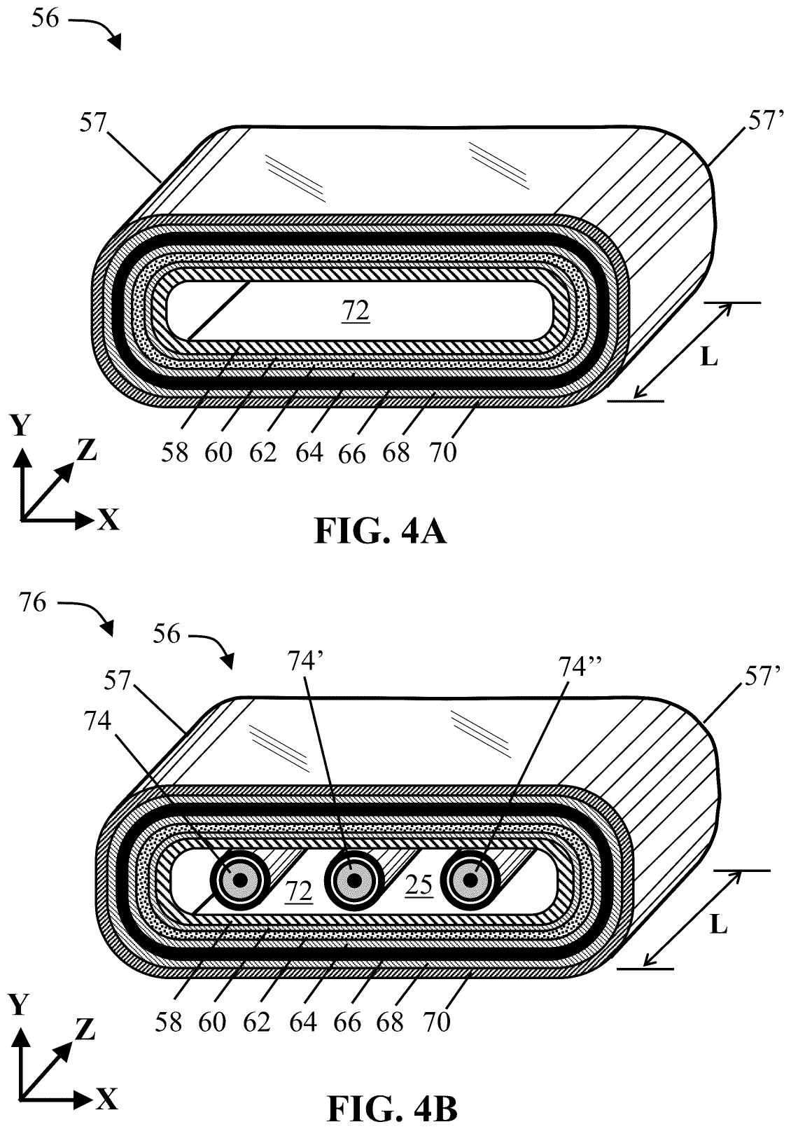

FIG. 4A shows a schematic perspective cross-sectional view of an example of a rectangular AC choke 56 having an axial length=L (along the Z-axis direction), with four rounded corners 57, 57′, etc., according to the present disclosure. Choke 56 comprises a hollow magnetic core 58 made of a magnetic material (e.g., iron-based ferrite material, or nanocrystalline iron-based amorphous ribbon material), that defines a rectangular axial bore 72 located inside of magnetic core 58. Moving outwards, the next layer comprises a first layer of a thermally conductive material 60 (e.g., thermal paste). Moving outwards, the next layer comprises a dielectric separator 62, made of a dielectric material (e.g., a Polyamide, Polyphenylene Sulfide, an Epoxy Resin, and/or a Polycarbonate, etc.) Moving outwards, the next layer comprises a second layer of a thermally conductive material 64 (e.g., thermal paste). Moving outwards, the next layer comprises a metallic casing 66 (e.g., aluminum alloy or steel alloy, or a combination thereof). Moving outwards, the next layer comprises a third layer of a thermally conductive material 68 (e.g., thermal paste). Finally, the outermost layer of choke 56 comprises a dielectric outer jacket 70 made of an insulating material (e.g., a Polyamide, Polyphenylene Sulfide, an Epoxy Resin, and/or a Polycarbonate, etc.)

Referring still to FIG. 4A, in some embodiments the third layer of thermally conductive material 68 (e.g., thermal paste) and the dielectric outer jacket 70 may be optionally omitted. This configuration makes the metallic casing 66 the outermost layer, in this embodiment.

FIG. 4B shows a schematic perspective cross-sectional view of an example of a rectangular AC choke assembly 76 having an axial length=L (along the Z-axis direction), with four rounded corners 57, 57′, etc., and three parallel, coaxial electrical cables 74, 74′, and 74″ disposed inside of, and passing through, the interior axial bore 72 of choke 56, according to the present disclosure. The remaining, unused open space 25 located in-between coaxial electrical cables 74, 74′, and 74″, may be filled with a dielectric material, in some embodiments.

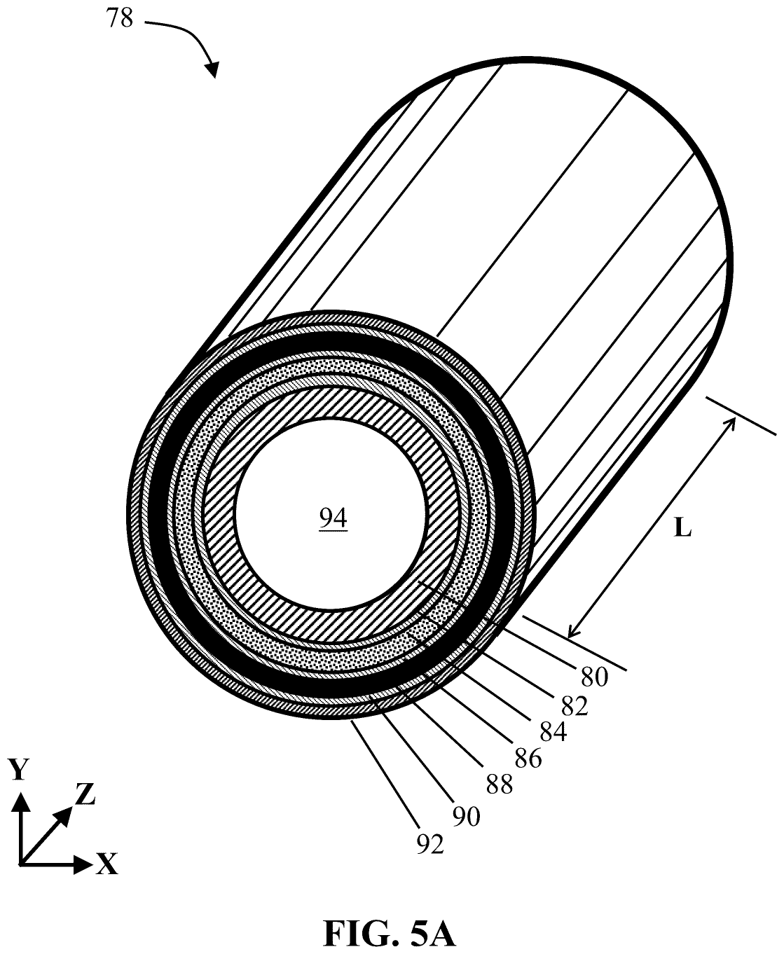

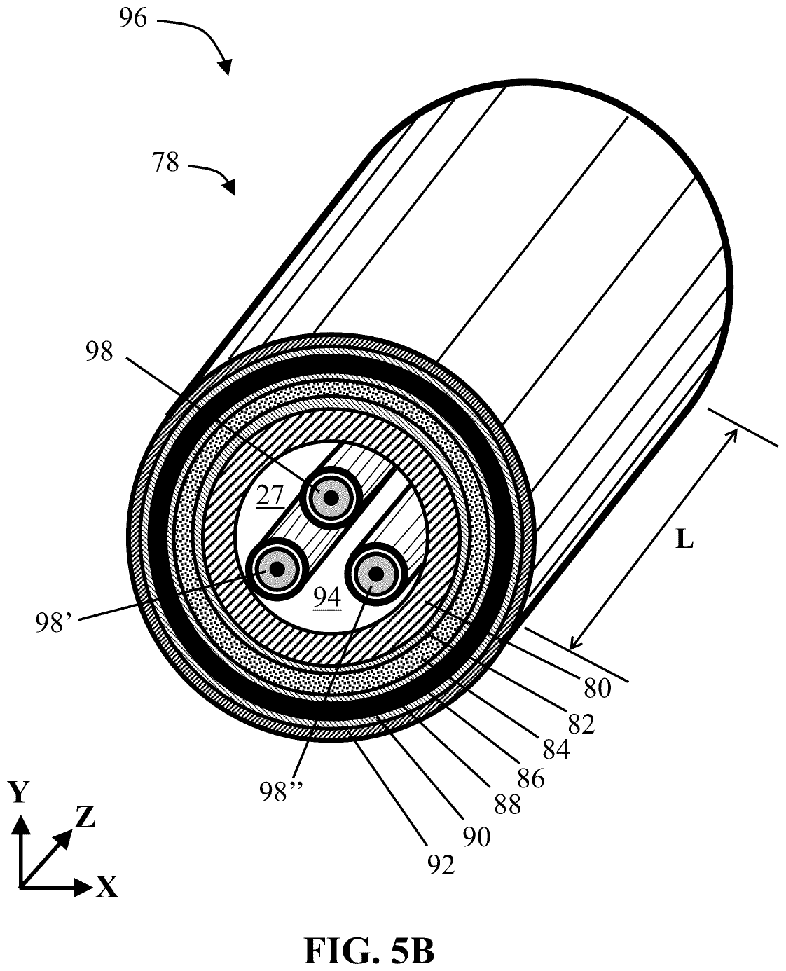

FIG. 5A shows a schematic perspective cross-sectional view of an example of a circular AC choke 78, having an axial length =L (along the Z-axis direction), according to the present disclosure. Choke 78 comprises a hollow, circular magnetic core 80 made of a magnetic material (e.g., iron-based ferrite material, or nanocrystalline iron-based amorphous ribbon material), that defines a circular axial bore 94 located inside of magnetic core 80. Moving outwards, the next layer comprises a first layer of a thermally conductive material 82 (e.g., thermal paste). Moving outwards, the next layer comprises a circular dielectric separator 84, made of a dielectric material (e.g., a Polyamide, Polyphenylene Sulfide, an Epoxy Resin, and/or a Polycarbonate, etc.). Moving outwards, the next layer comprises a second layer of a thermally conductive material 86 (e.g., thermal paste). Moving outwards, the next layer comprises a circular metallic casing 88 (e.g., aluminum alloy or steel alloy, or a combination thereof). Moving outwards, the next layer comprises a third layer of a thermally conductive material 90 (e.g., thermal paste). Finally, the outermost layer of choke 78 comprises a circular dielectric outer jacket 92 made of an insulating material (e.g., a Polyamide, Polyphenylene Sulfide, an Epoxy Resin, and/or a Polycarbonate, etc.)

Referring still to FIG. 5A, in some embodiments the third layer of thermally conductive material 90 (e.g., thermal paste) and the dielectric outer jacket 92 may be optionally omitted. This configuration makes the metallic casing 88 the outermost layer, in this embodiment.

FIG. 5B shows a schematic perspective cross-sectional view of an example of a circular AC choke assembly 96 with three parallel, coaxial electrical cables 98, 98′, and 98″ disposed inside of, and passing through, the interior bore 94 of choke 78, according to the present disclosure. The remaining, unused open space 27 located in-between coaxial electrical cables 98, 98′, and 98″ may be filled with a dielectric material, in some embodiments.

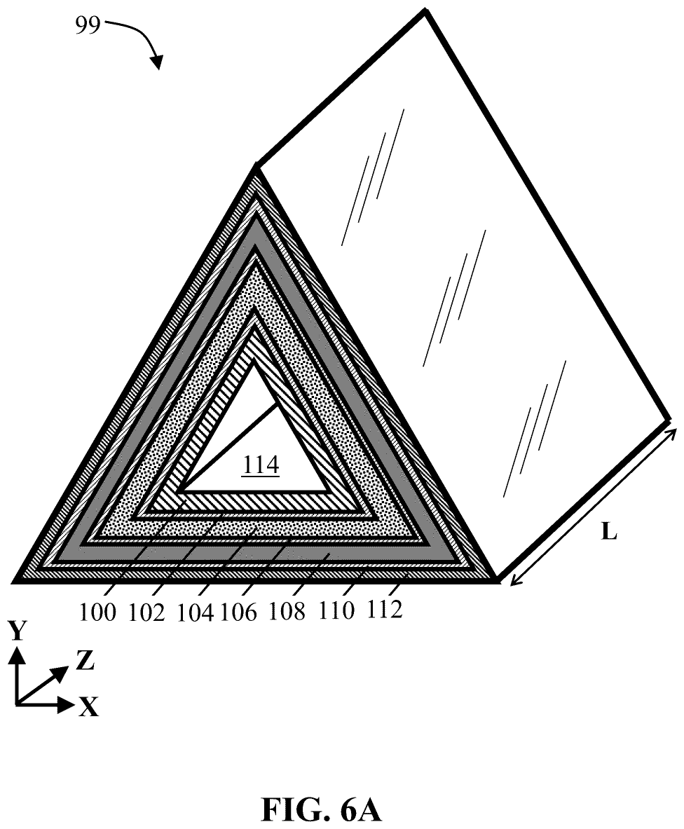

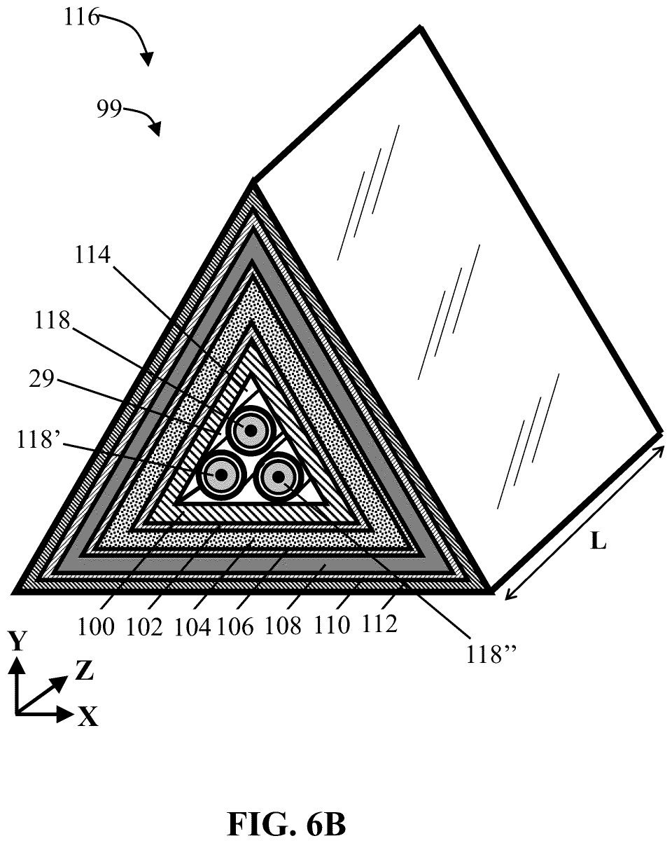

FIG. 6A shows a schematic perspective cross-sectional view of an example of a triangular AC choke 99, having an axial length=L (along the Z-axis direction), according to the present disclosure. Choke 99 comprises a hollow triangular magnetic core 100 made of a magnetic material (e.g., iron-based ferrite material, or nanocrystalline iron-based amorphous ribbon material), that defines a triangular axial bore 114 located inside of magnetic core 100. Moving outwards, the next layer comprises a first layer of a thermally conductive material 102 (e.g., thermal paste). Moving outwards, the next layer comprises a triangular dielectric separator 104, made of a dielectric material (e.g., a Polyamide, Polyphenylene Sulfide, an Epoxy Resin, and/or a Polycarbonate, etc.) Moving outwards, the next layer comprises a second layer of a thermally conductive material 106 (e.g., thermal paste). Moving outwards, the next layer comprises a triangular metallic casing 108 (e.g., aluminum alloy or steel alloy, or a combination thereof). Moving outwards, the next layer comprises a third layer of a thermally conductive material 110 (e.g., thermal paste). Finally, the outermost layer of choke 99 comprises a triangular dielectric outer jacket 112 made of an insulating material (e.g., a Polyamide, Polyphenylene Sulfide, an Epoxy Resin, and/or a Polycarbonate, etc.).

Referring still to FIG. 6A, in some embodiments the third layer of thermally conductive material 110 (e.g., thermal paste) and the dielectric outer jacket 112 may be optionally omitted. This configuration makes the triangular metallic casing 108 the outermost layer, in this embodiment.

FIG. 6B shows a schematic perspective cross-sectional view of an example of a triangular AC choke assembly 116 with three parallel, coaxial electrical cables 118, 118′, 118″ disposed inside of, and passing through, the interior axial bore 114 of choke 100, according to the present disclosure.

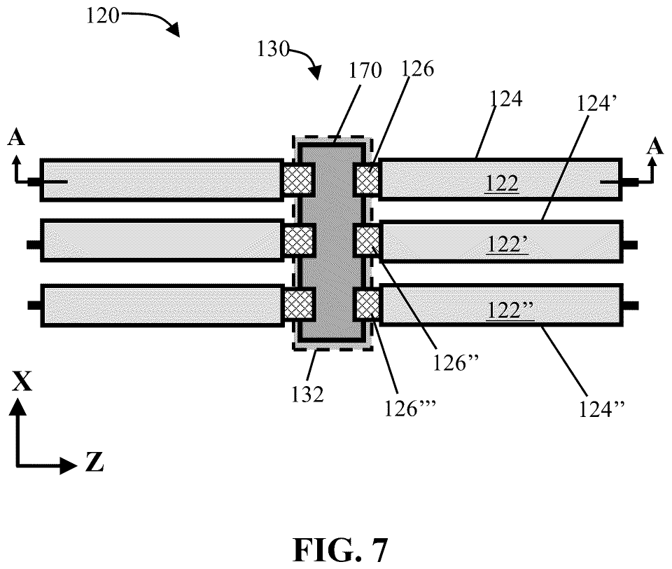

FIG. 7 shows a schematic top plan view of an example of an AC choke assembly 120 comprising an AC choke 130 with three parallel, coaxial electrical cables 122, 122′, and 122″ disposed inside of, and passing through, choke 130 in the Z-axis direction, according to the present disclosure. In this embodiment, the dielectric outer jacket 124, 124′, 124″ of coaxial electrical cables 122, 122′, and 122″ have been removed to expose cut conductive coaxial shield ends 126, 126′, and 126″, respectively. AC choke 130 may have a rectangular, circular, or triangular cross-section, as previously shown. In this embodiment, optional dielectric outer cover 132 surrounding AC choke 130 is shown illustrated as a dashed line, indicating that dielectric outer cover 132 is not a required feature. In this embodiment, AC choke 130 is located in a middle portion along the Z-axis of the three coaxial electrical cables 122, 122′, and 122″. Metallic casing 170 is disposed inside of AC choke 130. Cut conductive coaxial shield ends 126, 126′, and 126″ may be connected to the top (or bottom) of metallic casing 170. Cut conductive coaxial shield ends 126, 126′, and 126″ are discontinuous across AC choke 130

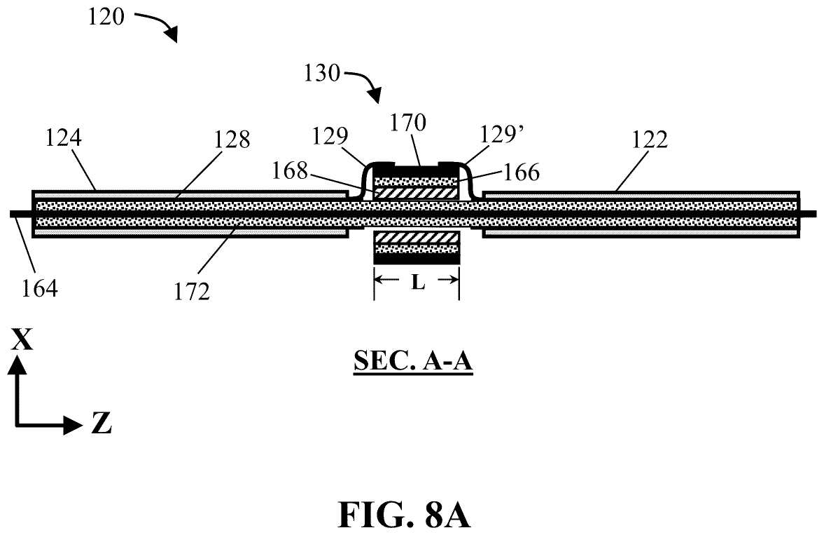

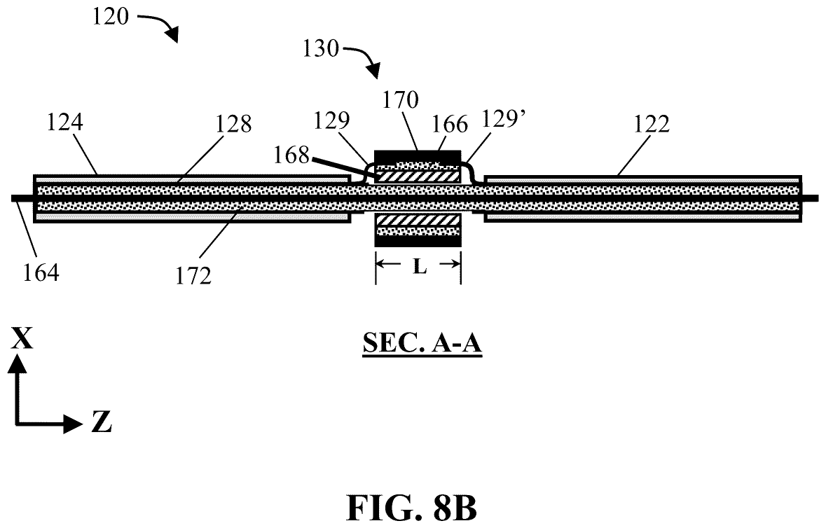

FIG. 8A shows a schematic side cross-section view (Section A-A) of the example shown in FIG. 7 of an AC choke assembly 120 comprising a coaxial electrical cable 122 electrically and mechanically integrated with an AC choke 130 having an axial length=L (along the Z-axis direction), according to the present disclosure. Coaxial electrical cable 122 comprises an axial central conductor 164 surrounded by a coaxial dielectric insulator 172, which is surrounded by a conductive coaxial shield 128, which is covered by dielectric coaxial jacket 124. In this embodiment, a short middle portion (longer than axial length, L) of dielectric coaxial jacket 124 is cut and removed. Then, left and right ends 129 and 129′ of conductive coaxial shield 128 are cut in the middle section of coaxial cable 122 and each of the left and right cut shield ends 129 and 129′ are peeled away from coaxial dielectric insulator 172, while remaining connected to coaxial shield 128. Cut shield ends 129 and 129′ may then be electrically connected to the top (or bottom) of the left and right sides of metallic casing 170, respectively. The cut shield ends 129 and 129′ may be connected to metallic casing 170 by soldering, screwing, laser welding, or using crimped connections (which may be soldered and crimped). Coaxial dielectric insulator 172 may pass through AC choke 130 in a continuous fashion. Optionally, a ferrule (not shown) may be used to connect cut shield ends 129 and 129′ to metallic casing 170.

FIG. 8B shows a schematic side cross-section view (Section A-A) of the example shown in FIG. 7 of an AC choke assembly 120 comprising a coaxial electrical cable 122 electrically and mechanically integrated with an AC choke 130 having an axial length=L (along the Z-axis direction), according to the present disclosure. Coaxial electrical cable 122 comprises an axial central conductor 164 surrounded by coaxial dielectric insulator 172, which is surrounded by conductive coaxial shield 128, which is covered by dielectric coaxial jacket 124. In this embodiment, a short middle portion (longer than axial length, L) of dielectric coaxial jacket 124 is cut and removed. Then, left and right ends 129 and 129′ of conductive coaxial shield 128 are cut in the middle section of coaxial cable 122 and each of the left and right cut shield ends 129 and 129′ are peeled away from coaxial dielectric insulator 172, while remaining connected to coaxial shield 128. Cut shield ends 129 and 129′ may then be electrically connected in-between left and right sides of metallic casing 170 and dielectric separator 166, respectively. Coaxial dielectric insulator 172 may pass through AC choke 130 in a continuous fashion. The cut shield ends 129 and 129′ may be connected to metallic casing 170 by soldering, screwing, laser welding, or using crimped connections (which may be soldered and crimped). Optionally, a ferrule (not shown) may be used to connect cut shield ends 129 and 129′ to metallic casing 170.

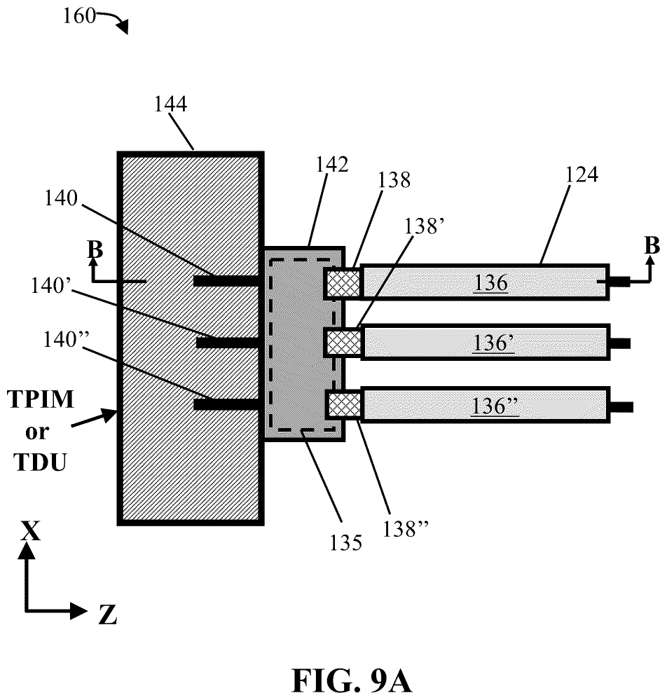

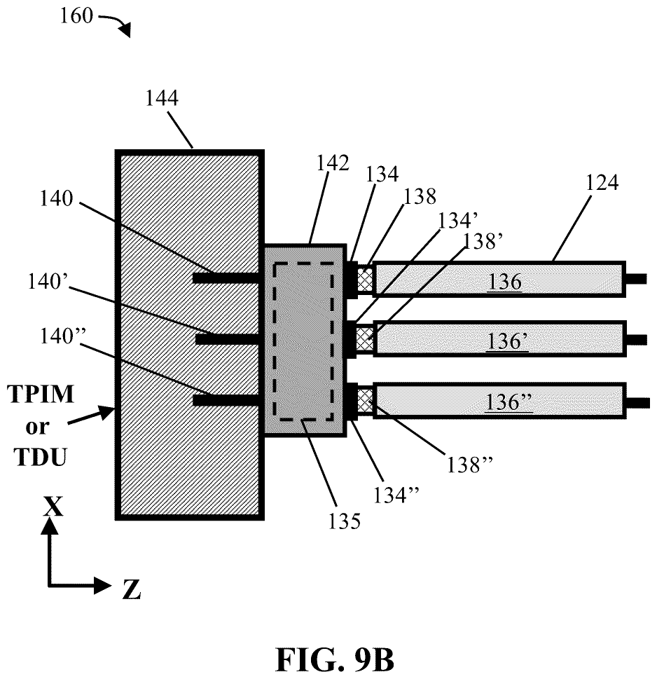

FIG. 9A shows a schematic top plan view of an example of an AC choke assembly 160 comprising an AC choke 142 attached to either a traction drive unit (TDU) 144 or to a traction power invertor module (TPIM) 144, with three parallel, coaxial electrical cables 136, 136′, and 136″ disposed inside of, and passing through, AC choke 142 in the Z-axis direction, according to the present disclosure. A short end of dielectric coaxial jacket 124 is cut and removed. Then, the ends of conductive coaxial shields 138, 138′, and 138″ of coaxial electrical cables 136, 136′, and 136″, respectively, are exposed by peeling back the dielectric coaxial jacket 124 as they enter the right side of choke 142. Exposed coaxial shield ends 138, 138′, and 138″ may then be connected to the top (or bottom) of metallic casing 142. Note: interior magnetic core 135 is shown as a dashed hidden line.

FIG. 9B shows a schematic top plan view of an example of an AC choke assembly 160 comprising an AC choke 142 attached to either a traction drive unit (TDU) 144 or to a traction power invertor module (TPIM) 144, with three parallel, coaxial electrical cables 136, 136′, and 136″ disposed inside of, and passing through, AC choke 142 in the Z-axis direction, according to the present disclosure. A short end of dielectric coaxial jacket 124 is cut and removed. Then, conductive coaxial shield ends 138, 138′, and 138″ of coaxial electrical cables 136, 136′, and 136″, respectively, are exposed by peeling back dielectric coaxial jacket 124 as they enter the right side of choke 142. Three coax shield grounding ferrules 134, 134′ and 134″ are then connected (e.g., crimped and/or soldered) to exposed coaxial shield ends 138, 138′, and 138″, respectively. Coax shield grounding ferrules 134, 134′ and 134″ are also connected to the right side of metallic casing 142. Note: interior magnetic core 135 is shown as a dashed hidden line.

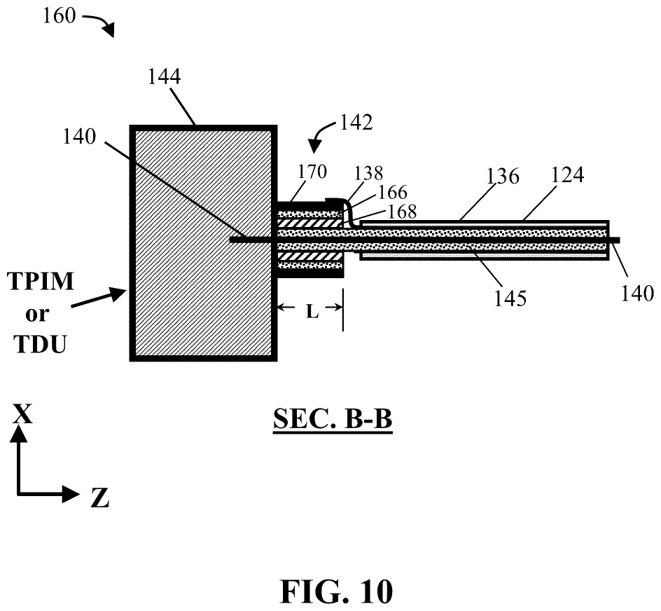

FIG. 10 shows a schematic side cross-section view (Section B-B) of the example shown in FIG. 9A of an AC choke assembly 160 comprising a coaxial electrical cable 136 electrically and mechanically integrated with an AC choke 142 that is attached to a TPIM or TDU power unit 144, according to the present disclosure. In this embodiment, conductive coaxial shield end 138 of coaxial electrical cable 136 is exposed by removing a left end of dielectric coaxial jacket 124 as it enters the right side of choke 142. A short end of conductive coaxial shield 138 is peeled away from coaxial dielectric insulator 145 and electrically connected to the top (or bottom) of the right side of metallic casing 170. Cut shield end 138 may be connected to metallic casing 170 by soldering, screwing, or using crimped connections (which may be soldered and crimped). Metallic casing 170 of choke 142 is attached to TPIM or TDU unit 144, and central axial conductor 140 penetrates the right side of TPIM or TDU unit 144 to make electrical contact with TPIM or TDU unit 144. Coaxial dielectric insulator 145 may pass through AC choke 130 in a continuous fashion.

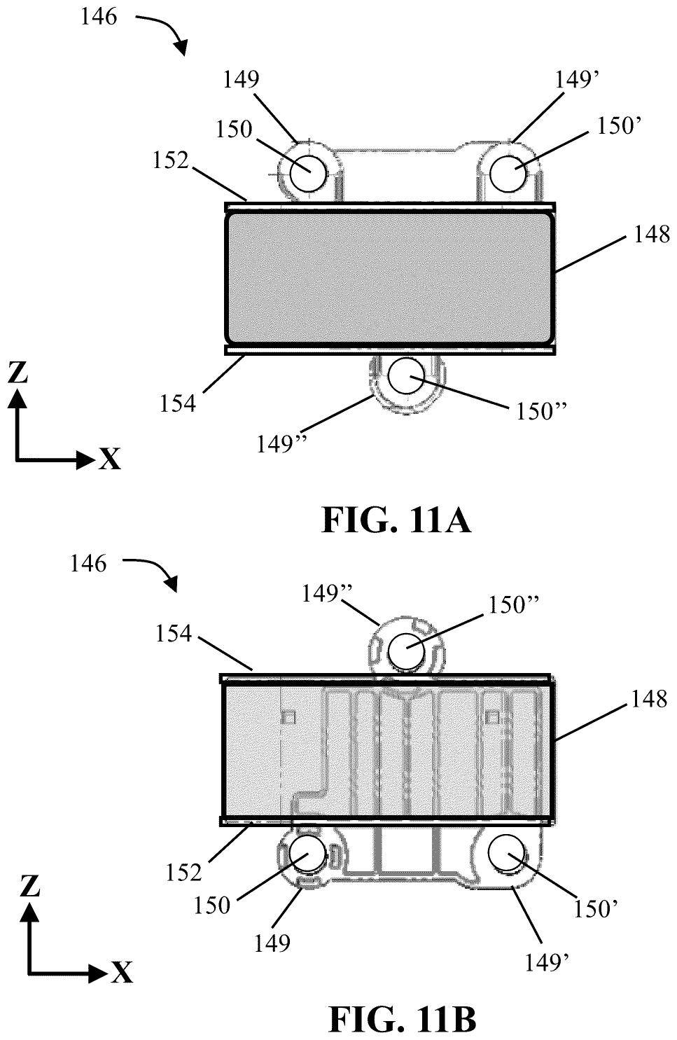

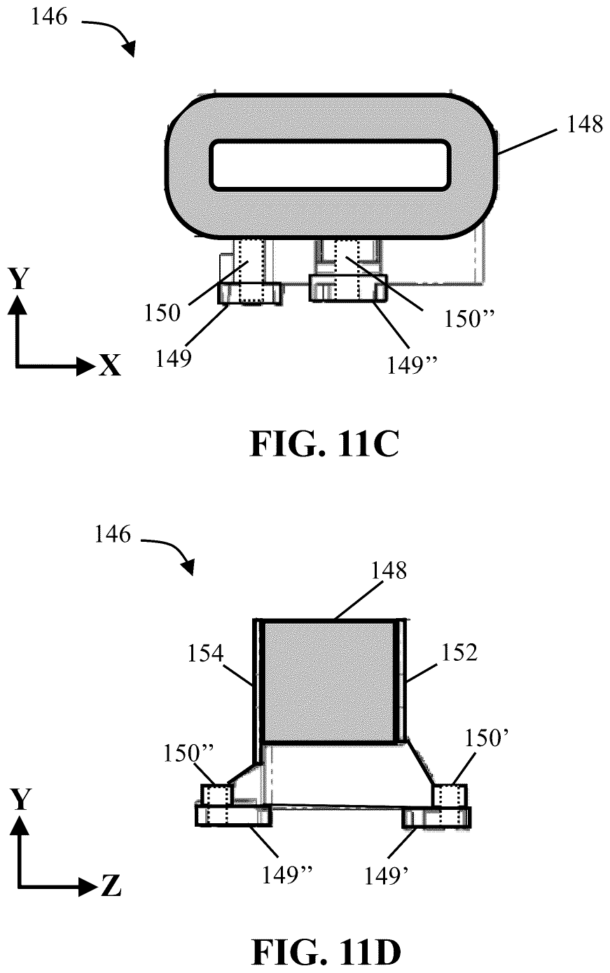

FIG. 11A shows a schematic top plan view of an example of an AC choke 148 housed in a sheet metal housing 146, according to the present disclosure. Housing 146 comprises a pair of parallel, sheet metal plates 152 and 154 that surround and securely hold choke 148. Housing 146 further comprises three bosses 149, 149′, 149″ that have central holes 150, 150′, and 150″, respectively for bolting housing unit 146 to a base (not shown).

FIG. 11B shows a schematic bottom plan view of an example of an AC choke 148 housed in a sheet metal housing 146, according to the present disclosure. Housing 146 comprises a pair of parallel, sheet metal plates 152 and 154 that surround and securely hold choke 148. Housing 146 further comprises three bosses 149, 149′, 149″ that have central holes 150, 150′, and 150″, respectively for bolting housing unit 146 to a base (not shown).

FIG. 11C shows a schematic front elevation view of an example of an AC choke 148 housed in a sheet metal housing 146, according to the present disclosure. Housing 146 comprises a pair of parallel, sheet metal plates 152 and 154 that surround and securely hold choke 148. Housing 146 further comprise bosses 149 and 149″ that have central holes 150 and 150″ respectively, for bolting housing unit 146 to a base (not shown).

FIG. 11D shows a schematic side elevation view of an example of an AC choke 148 housed in a sheet metal housing 146, according to the present disclosure. Housing 146 comprises a pair of parallel, sheet metal plates 152 and 154 that surround and securely hold choke 148. Housing 146 further comprises two bosses 149′, 149″ that each have central holes 150, 150′, respectively, for bolting housing unit 146 to a base (not shown).

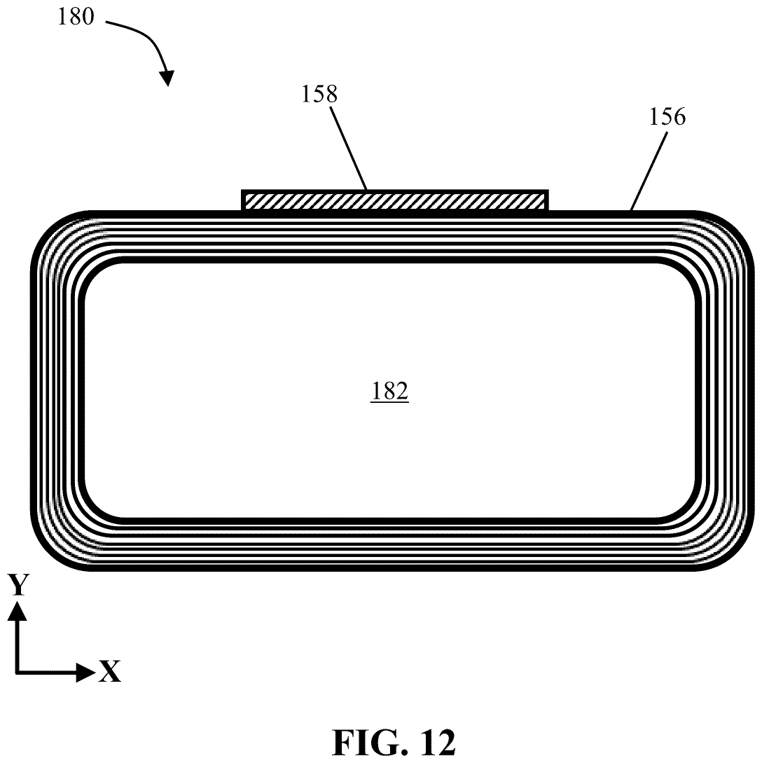

FIG. 12 shows a schematic front elevation view of an example of a magnetic core 156 of an AC choke 180, according to the present disclosure. In this embodiment, magnetic core 156 comprises a plurality of thin, nanocrystalline ribbons wound around in a rounded, rectangular geometry defining an axial bore 182 disposed inside of the core 156. Peeled-away coaxial shield strip 158 is electrically connected to the upper (or lower) surface of magnetic core 156. Optionally, a ferrule (not shown) may be used to connect peeled-away coaxial shield strip 158 to magnetic core 156. In some embodiments, a metallic casing is not used and conductive coaxial shield strip 158 is electrically connected to magnetic core 156 of AC choke 180.

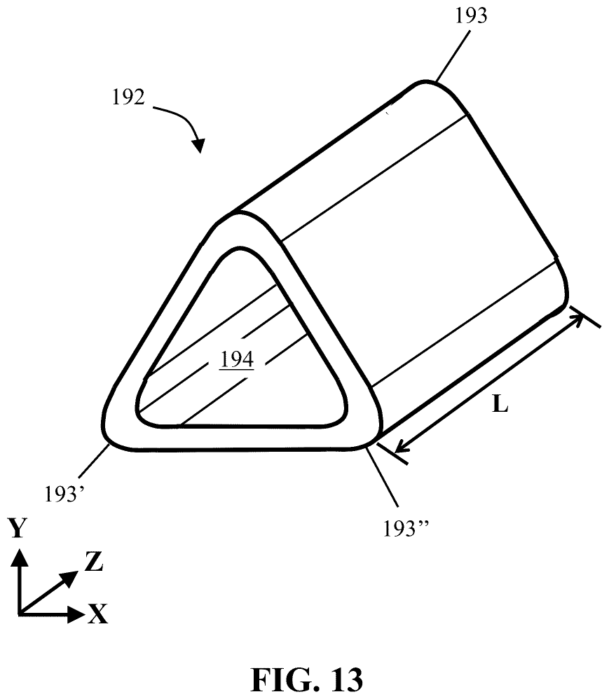

FIG. 13 shows a schematic perspective view of an example of a rounded triangular magnetic core 192, according to the present disclosure. In this embodiment, rounded triangular magnetic core 192 has three rounded corners 193, 193′, and 193″, and an axial bore 194 disposed inside of magnetic core 192 and having an axial length, L, which is aligned with the Z-axis.

FIG. 14 shows a schematic perspective view of an example of a vehicle 1 with an AC choke assembly 160, according to the present disclosure. Vehicle 1 has a vehicle body 2 with four road wheels 3, 3′, etc., and an AC choke assembly 160 connected to a traction drive unit (TDU) or Traction Power Invertor Module (TPIM) 144 that is connected to a traction drive motor (not shown).

In some embodiments, exposed surfaces of the AC choke are covered by a dielectric insulating material.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. All embodiments and examples disclosed herein are non-limiting embodiments and non-limiting examples. The words “a”, “an”, “the”, “at least one”, and “one or more” are used interchangeably to indicate that at least one of the items is present.

What is claimed is:

1. An alternating current (AC) choke for reducing common mode and bearing currents in AC drive systems, comprising:
a magnetic core;
an axial bore defined by the magnetic core;
a dielectric separator surrounding the magnetic core; and
a metallic casing surrounding the dielectric separator; and
wherein the dielectric separator electrically isolates the magnetic core from the metallic casing.

2. The AC choke of claim 1, further comprising:
a first layer of a thermal interface material disposed in-between the magnetic core and the dielectric separator; and
a second layer of the thermal interface material disposed in-between the dielectric separator and the metallic casing.

3. The AC choke of claim 2, further comprising:
a dielectric outer jacket surrounding the metallic casing; and
a third layer of the thermal interface material disposed in-between the metallic casing and the dielectric outer jacket.

4. The AC choke of claim 1, wherein exposed surfaces of the AC choke are covered in a dielectric insulating material.

5. The AC choke of claim 1,
wherein the magnetic core comprises a ferrous material selected from the group consisting of a nanocrystalline ferrous material, a ferrite material, and/or a combination thereof;
wherein the dielectric separator comprises polyphenylene sulfide; and
wherein the metallic casing comprises an aluminum alloy and/or a steel alloy, and/or a combination thereof.

6. The AC choke of claim 3, wherein the dielectric outer jacket comprises polyphenylene sulfide.

7. The AC choke of claim 1, wherein the magnetic core has a shape that is rectangular, rounded rectangular, circular, triangular, or rounded triangular.

8. The AC choke of claim 1, further comprising at least one coaxial electrical cable disposed inside of, and passing through, the bore of the magnetic core.

9. The AC choke of claim 1, wherein the magnetic core comprises a plurality of nanocrystalline ferrous ribbons wound in a rounded rectangular geometry with the axial bore disposed inside of the magnetic core.

10. An alternating current (AC) choke assembly for reducing common mode and bearing currents in AC drive systems, comprising:
(a) an AC choke, comprising:
a magnetic core;
an axial bore defined by the magnetic core;
a dielectric separator, surrounding the magnetic core; and
a metallic casing, surrounding the dielectric separator;
wherein the AC choke assembly further comprises:
(b) at least one coaxial electrical cable disposed inside of, and passing through, the axial bore of the magnetic core;
wherein the dielectric separator electrically isolates the magnetic core from the metallic casing; and
wherein the at least one coaxial electrical cable comprises:
(1) an axial central conductor;
(2) a coaxial dielectric insulator surrounding the axial central conductor;
(3) a conductive coaxial shield surrounding the coaxial dielectric insulator; and
(4) a dielectric coaxial jacket surrounding the conductive coaxial shield.

11. The AC choke assembly of claim 10,
wherein a portion of the dielectric coaxial jacket and the conductive coaxial shield are peeled away from the at least one coaxial electrical cable;
thereby defining an exposed portion of the conductive coaxial shield; and
thereby defining an unshielded axial portion of the at least one coaxial electrical cable.

12. The AC choke assembly of claim 11, wherein the AC choke is located at a middle section of the at least one coaxial electrical cable.

13. The AC choke assembly of claim 11, wherein the AC choke is located at an end of the at least one coaxial electrical cable.

14. The AC choke assembly of claim 11, wherein the AC choke is located over the unshielded axial portion of the at least one coaxial electrical cable.

15. The AC choke assembly of claim 11, wherein the exposed portion of the conductive coaxial shield is electrically connected to an outer surface of the metallic casing of the AC choke.

16. The AC choke assembly of claim 11, wherein the exposed portion of conductive coaxial shield is electrically connected to an inner surface of the magnetic core of the AC choke.

17. The AC choke assembly of claim 11, wherein the metallic casing of the AC choke is connected to a first metallic housing of a traction drive unit (TDU) or to a traction power invertor module (TPIM).

18. The AC choke assembly of claim 11, further comprising three parallel coaxial electrical cables disposed inside of, and passing through, the axial bore of the magnetic core.

19. The AC choke assembly of claim 11,
wherein the metallic casing is eliminated; and
wherein the conductive coaxial shield is electrically connected to the magnetic core of the AC choke.

20. A vehicle, comprising:
a vehicle body;
one or more road wheels connected to the vehicle body; and
an alternating current (AC) choke assembly connected to the vehicle body;
wherein the AC choke assembly comprises:
(a) an AC choke, comprising:
a magnetic core;
an axial bore defined by the magnetic core;
a dielectric separator surrounding the magnetic core; and
a metallic casing surrounding the dielectric separator;
(b) at least one coaxial electrical cable disposed inside of, and passing through, the axial bore of the magnetic core; and
(c) a traction drive unit (TDU) or a traction power invertor module (TPIM) connected to the AC choke;
wherein the dielectric separator electrically isolates the magnetic core from the metallic casing;
wherein the at least one coaxial electrical cable comprises:
(1) an axial central conductor;
(2) a coaxial dielectric insulator surrounding the axial central conductor;
(3) a conductive coaxial shield surrounding the coaxial dielectric insulator; and
(4) a dielectric coaxial jacket surrounding the conductive coaxial shield;
wherein the axial central conductor is connected to the TDU or TPIM; and
wherein the conductive coaxial shield is connected to the metallic casing.
